(19) United States
(12) Patent Application Publication
(10) Pub. No.: US 2024/0422031 A1
(43) Pub. Date: Dec. 19, 2024

(54) SENSING METHOD AND APPARATUS, AND COMMUNICATION DEVICE

(71) Applicant: VIVO MOBILE COMMUNICATION CO., LTD., Dongguan (CN)

(72) Inventors: Jian YAO, Dongguan (CN); Dajie JIANG, Dongguan (CN); Baolong CHEN, Dongguan (CN); Pucong WANG, Dongguan (CN)

(73) Assignee: VIVO MOBILE COMMUNICATION CO., LTD., Dongguan (CN)

(21) Appl. No.: 18/814,419

(22) Filed: Aug. 23, 2024

Related U.S. Application Data
(63) Continuation of application No. PCT/CN2023/077436, filed on Feb. 21, 2023.

(30) Foreign Application Priority Data
Feb. 25, 2022 (CN) 202210179890.1

(51) Int. Cl. H04L 25/02

(52) U.S. Cl. CPC H04L 25/0204; H04L 25/0222; H04L 25/0242

(57) ABSTRACT

This application discloses a sensing method and apparatus, and a communication device. The sensing method includes: A first device obtains at least one sensing measurement result based on at least one of a time domain variance, standard deviation, or coefficient of variation of at least one time-frequency domain channel matrix, and the first device obtains a target sensing measurement result based on the at least one sensing measurement result.

### CROSS-REFERENCE TO RELATED APPLICATIONS

This application is a continuation of International Application No. PCT/CN2023/077436, filed Feb. 21, 2023, which claims priority to Chinese Patent Application No. 202210179890.1, filed Feb. 25, 2022. The entire contents of each of the above-referenced applications are expressly incorporated herein by reference.

### TECHNICAL FIELD

This application relates to the field of communication technologies, and in particular, to a sensing method and apparatus, and a communication device.

### BACKGROUND

In addition to the ability to communicate, mobile communication systems in the future have the ability to sense. To be specific, by transmitting and receiving radio signals, one or more devices with the sensing ability can sense information about a target object such as a position, a range, and a velocity, or detect, track, identify, and image a target object, event, environment, or the like, or perform other functions. Although a sensing function is currently available in a wide variety of types, there is no clear solution to implementing a sensing function in scenarios such as intrusion detection and trajectory tracking.

### SUMMARY

Embodiments of this application provide a sensing method and apparatus, and a communication device.

According to a first aspect, a sensing method is provided, including:
obtaining, by a first device, at least one sensing measurement result based on at least one of a time domain variance, standard deviation, or coefficient of variation of at least one time-frequency domain channel matrix, where the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points; and
obtaining, by the first device, a target sensing measurement result based on the at least one sensing measurement result.

According to a second aspect, a sensing method is provided, including:
obtaining, by a second device, information that is sent by a first device based on a first signal; and
obtaining, by the second device, a target sensing measurement result, where
the target sensing measurement result is obtained by the first device based on at least one sensing measurement result, the sensing measurement result is obtained based on at least one of a time domain variance, standard deviation, or coefficient of variation of a time-frequency domain channel matrix, the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on the received first signal by the first device, the time-frequency domain channel matrix is an M×N or N×M matrix, M represents a quantity of frequency domain sampling points, and N represents a quantity of time domain sampling points.

According to a third aspect, a sensing apparatus is provided, including:
a first obtaining module, configured to obtain at least one sensing measurement result based on at least one of a time domain variance, standard deviation, or coefficient of variation of at least one time-frequency domain channel matrix, where the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the sensing apparatus, the time-frequency domain channel matrix is an M×N or N×M matrix, M represents a quantity of frequency domain sampling points, and N represents a quantity of time domain sampling points; and
a second obtaining module, configured to obtain a target sensing measurement result based on the at least one sensing measurement result.

According to a fourth aspect, a sensing apparatus is provided, including:
a third obtaining module, configured to obtain a target sensing measurement result, where the target sensing measurement result is obtained by a first device based on at least one sensing measurement result, the sensing measurement result is obtained based on at least one of a time domain variance, standard deviation, or coefficient of variation of a time-frequency domain channel matrix, the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points.

According to a fifth aspect, a communication device is provided. The communication device includes a processor and a memory. The memory stores a program or instructions that are executable on the processor. When the program or instructions are executed by the processor, steps in the sensing method according to the first aspect or the second aspect are performed.

According to a sixth aspect, a first device is provided, including a processor and a communication interface. The processor is configured to: obtain at least one sensing measurement result based on at least one of a time domain variance, standard deviation, or coefficient of variation of at least one time-frequency domain channel matrix, where the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points; and obtain a target sensing measurement result based on the at least one sensing measurement result.

According to a seventh aspect, a second device is provided, including a processor and a communication interface. The communication interface is configured to obtain a target sensing measurement result, where

the target sensing measurement result is obtained by a first device based on at least one sensing measurement result, the sensing measurement result is obtained based on at least one of a time domain variance, standard deviation, and coefficient of variation of a time-frequency domain channel matrix, the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points.

According to an eighth aspect, a sensing system is provided, including a first device and a second device. The first device may be configured to perform steps in the sensing method according to the first aspect. The second device may be configured to perform steps in the sensing method according to the second aspect.

According to a ninth aspect, a readable storage medium is provided. The readable storage medium stores a program or instructions. When the program or instructions are executed by a processor, steps in the method according to the first aspect or steps in the method according to the second aspect are performed.

According to a tenth aspect, a chip is provided. The chip includes a processor and a communication interface. The communication interface is coupled to the processor. The processor is configured to run a program or instructions, to implement the method according to the first aspect or the method according to the second aspect.

According to an eleventh aspect, a computer program product is provided. The computer program product is stored in a storage medium. The computer program product is executed by at least one processor to perform steps in the sensing method according to the first aspect.

In the embodiments of this application, the first device performs channel estimation on the received first signal, to obtain the at least one time-frequency domain channel matrix;

obtains the at least one sensing measurement result based on the at least one of the time domain variance, the time domain standard deviation, and the time domain coefficient of variation of the at least one time-frequency domain channel matrix; and obtains the target sensing measurement result based on the at least one sensing measurement result. Then, based on the target sensing measurement result, information about a target object in a target environment such as a position and a velocity can be obtained, implementing a wireless sensing function in scenarios such as intrusion detection and trajectory tracking.

### BRIEF DESCRIPTION OF THE DRAWINGS

FIG. 1 is a diagram of a structure of a communication system to which embodiments of this application are applicable;

FIG. 2 is a first schematic flowchart of a sensing method according to an embodiment of this application;

FIG. 3 is a diagram of a time domain calculation window according to an embodiment of this application;

FIG. 4 is a second schematic flowchart of a sensing method according to an embodiment of this application;

FIG. 5 is a first diagram of modules of a sensing apparatus according to an embodiment of this application;

FIG. 6 is a second diagram of a module of a sensing apparatus according to an embodiment of this application;

FIG. 7 is a block diagram of a structure of a communication device according to an embodiment of this application;

FIG. 8 is a block diagram of a structure of a terminal according to an embodiment of this application;

FIG. 9 is a first block diagram of a structure of a network-side device according to an embodiment of this application; and

FIG. 10 is a second block diagram of a structure of a network-side device according to an embodiment of this application.

### DETAILED DESCRIPTION

The following clearly describes the technical solutions in embodiments of this application with reference to the accompanying drawings in embodiments of this application. It is clear that the described embodiments are some rather than all of embodiments of this application. All other embodiments obtained by persons of ordinary skill in the art based on embodiments of this application all fall within the protection scope of this application.

In the specification and claims of this application, the terms such as “first” and “second” are intended to distinguish between similar objects but not to describe a particular order or sequence. It should be understood that the terms used in this way are interchangeable in appropriate circumstances, so that the operations in embodiments of this application can be implemented in an order other than the orders illustrated or described herein. In addition, objects distinguished between by “first” and “second” are usually of a same category, and a quantity of objects is not limited. For example, there may be one or more first objects. In addition, in the specification and claims, “and/or” indicates at least one of the connected objects, and the character “/” generally indicates an “or” relationship between the contextually associated objects.

It should be noted that the technologies described in embodiments of this application are not limited to being used in Long Term Evolution (LTE)/LTE-Advanced (LTE-A) systems, and may also be used in other wireless communication systems such as Code Division Multiple Access (CDMA) systems, Time Division Multiple Access (TDMA) systems, Frequency Division Multiple Access (FDMA) systems, Orthogonal Frequency Division Multiple Access (OFDMA) systems, Single-carrier Frequency Division Multiple Access (SC-FDMA) systems, and other systems. The terms “system” and “network” in embodiments of this application are usually used interchangeably. The technologies described can be used in the systems and radio technologies mentioned above, and can also be used in other systems and radio technologies. The following uses a New Radio (NR) system as an example, and NR terms are used in most of the following descriptions. However, these technologies can also be used in applications other than NR system applications, for example, a 6^{th} Generation (6G) communication system.

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet personal computer, a laptop computer which is also referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a vehicle user equipment (VUE), a pedestrian user equipment (PUE), a smart home device (a home device with wireless communication functionality, for example, a refrigerator, a TV, a washing machine, or furniture), a game console, a personal computer (PC), a teller machine, or a self-service machine. A wearable device includes a smart watch, a smart band, smart earphones, smart glasses, smart jewelry (a smart bracelet, a smart ring, a smart necklace, a smart anklet, and the like), a smart wristband, smart clothes, and the like. It should be noted that a specific type of the terminal 11 is not limited in this embodiment of this application. The network-side device 12 may include an access network device or a core network device. The access network device 12 may also be referred to as a radio access network device, a Radio Access Network (RAN), a radio access network function, or a radio access network unit. The access network device 12 may include a base station, a Wireless Local Area Network (WLAN) access point, a Wireless Fidelity (Wi-Fi) node, or the like. A base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the field. The base station is not limited to a particular technical term, provided that same technical effects are achieved. It should be noted that in this embodiment of this application, only a base station in an NR system is used as an example for description, but a specific type of the base station is not limited. The core network device may include, but is not limited to, at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), Centralized network configuration (CNC), a Network Repository Function (NRF), a Network Exposure Function (NEF), a Local NEF (L-NEF), a Binding Support Function (BSF), an Application Function (AF), or the like. It should be noted that in this embodiment of this application, only a core network device in an NR system is used as an example for description, but a specific type of the core network device is not limited.

For a purpose of enabling persons skilled in the art to better understand embodiments of this application, the following descriptions are first provided.

Communication sensing integration means to design communication and sensing functions together through spectrum sharing and hardware sharing in a system. While transferring information, the system can sense information such as a position, a range, and a velocity, and detect, track, and identify a target object or event. In this way, a communication system and a sensing system complement each other, improving overall performance and bringing better service experiences.

In addition to the ability to communicate, mobile communication systems in the future, for example, Beyond 5G (B5G) systems or 6G systems, have the ability to sense. To be specific, by transmitting and receiving radio signals, one or more devices with the sensing ability can sense information about a target object such as a position, a range, and a velocity, or detect, track, identify, and image a target object, event, environment, or the like, or perform other functions. With deployment of small base stations that operate in high frequency bands such as millimetric-wave and terahertz bands and provide large bandwidths in 6G networks in the future, sensing resolution increases significantly, compared to sensing resolution achieved by base stations operating in centimetric-wave bands. Therefore, the 6G networks can provide finer sensing services.

Communication radar integration is a typical application of communication sensing integration. In the past, a radar system and a communication system are strictly distinguished from each other due to their different objects of study and focuses of attention, and the two systems are studied separately in most scenarios. Actually, the radar system and the communication system both serve as typical manners of sending, obtaining, processing, and exchanging information. Therefore, there are many similarities between the two systems in working principles, system architectures, and frequency bands. Designing communication and radar together is highly feasible, which is primarily proved by the following several aspects: Firstly, the communication system and the sensing system are both based on the theory of electromagnetic waves, and obtain and transfer information by transmitting and receiving electromagnetic waves; secondly, the communication system and the sensing system both have structures such as antennas, transmitting ends, receiving ends, and signal processors, and have a large quantity of same hardware resources; with development of technologies, the two systems also operate in an increasing quantity of same frequency bands; and in addition, there are similarities in key technologies such as signal modulation, reception detection, and waveform design. Integrating the communication system and the radar system can bring many advantages, such as reducing costs, sizes, power consumption, and mutual interference and improving spectral efficiency. In this way, overall system performance is improved.

Currently, there are quite a few studies related to designing radar and communication systems together. Typical joint designs include: spectrum coexistence, in which the two systems operate independently, but may allow information to be exchanged to reduce mutual interference; receiving end shared, in which transmitting ends of the two systems transmit signal waveforms of their respective systems, but the waveforms of the two systems need to be orthogonal so that reception detection of the two systems is not affected; transmitting end shared, in which the transmitting end transmits a joint waveform of the radar and communication systems; and receiving and transmitting ends shared, in which resources at receiving and transmitting sides of the two systems are shared, also requiring use of a joint waveform or waveforms that are orthogonal.

When sensing is performed, sensing may be performed in monostatic mode, that is, transceiver co-addressing. A transmitting end transmits a signal that is used for sensing, and then receives and analyzes an echo signal and extracts a sensing parameter. For example, a base station serves as a transmitting end and a receiving end of a signal that is used for sensing, and a terminal or another object serves as a sensing target. In some embodiments, sensing may be performed in dualstatic/multistatic mode. To be specific, the transceiver is not co-located. A transmitting end transmits a signal that is used for sensing, and another receiving end receives and analyzes the signal and extracts a sensing parameter. For example, a base station 1 serves as a transmitting end of a signal that is used for sensing, and a terminal or a base station 2 serves as a receiving end of the signal that is used for sensing. Likewise, in monostatic or multistatic mode, a transmitting end of a signal that is used for sensing may be a terminal.

The communication system needs to send modulated symbols bearing information and pilot symbols used for channel estimation together, with a focus on decoding performance. A channel estimation algorithm of the communication system only needs to estimate a compound channel with limited unknown parameters, usually with increasing a throughput and improving reliability of transmission as optimization objectives. Performance metrics of concern are usually spectral efficiency, a channel capacity, a Signal to Noise Ratio (SNR), a Signal to Interference plus Noise Ratio (SINR), a Bit Error Rate (BER), a Block Error Rate (BLER), a Symbol Error Rate (SER), and the like. By contrast, the sensing system does not need to consider information bearing during signal transmission and usually uses optimized or unmodulated transmit signals, with a focus on changes made by a sensing target to the transmit signals, that is, response characteristics. Usually, increasing precision of parameter estimation is an optimization objective. Performance metrics may be a fuzzy function, a Cramer-Rao lower bound, a root mean squared error, mutual information, a rate distortion function, a radar-estimated rate, a Welch lower bound, and some metrics associated with sensing scenarios and requirements.

Currently, there are quite a few studies on implementing a sensing function by using a communication system. However, although sensing services are available in a wide variety of types, there is no clear solution to implementing a sensing function in an intrusion detection scenario.

With reference to the accompanying drawings, the following describes in detail sensing methods provided in embodiments of this application by using some embodiments and their application scenarios.

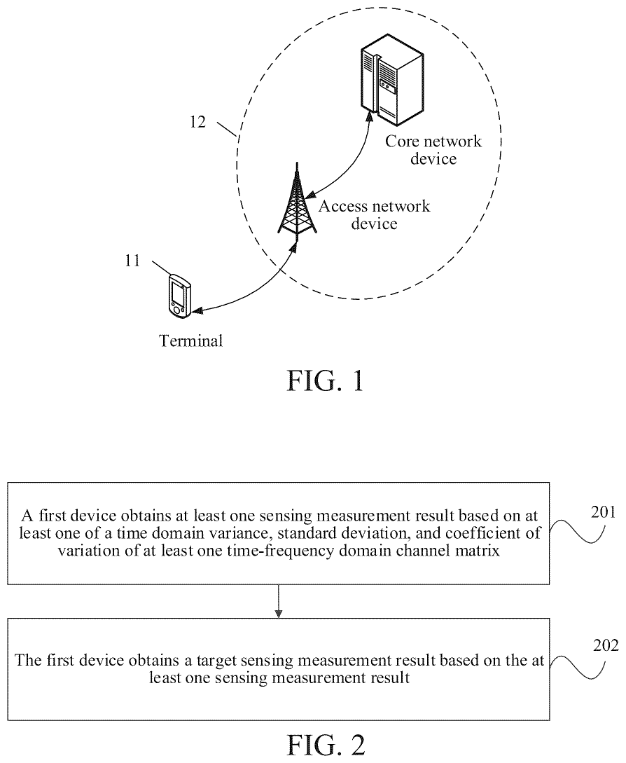

As shown in FIG. 2, an embodiment of this application provides a sensing method. The method includes the following steps.

Step 201: A first device obtains at least one sensing measurement result based on at least one of a time domain variance, standard deviation, or coefficient of variation of at least one time-frequency domain channel matrix, where the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of subcarriers (or a quantity of frequency domain sampling points), and N represents a quantity of time domain sampling points.

In this embodiment of this application, the first signal may be a sensing signal or a communication signal. The communication signal can be used for sensing. The first signal may be a signal that is used for obtaining information about a target object such as a position, a range, and a velocity, or a signal that is used for detecting, tracking, identifying, and imaging a target object, event, environment, or the like.

M and N are both positive integers.

One antenna transceiver combination may correspond to at least one time-frequency domain channel matrix. Herein, each sensing measurement result corresponds to at least one time-frequency domain channel matrix, and one antenna transceiver combination corresponds to one sensing measurement result.

For example, one antenna transceiver combination corresponds to two matrices: a first time-frequency domain channel matrix and a second time-frequency domain channel matrix. In this case, a sensing measurement result may be determined based on a variance of the first time-frequency domain channel matrix, then a sensing measurement result may be determined based on a standard deviation of the second time-frequency domain channel matrix, and a sensing measurement result corresponding to the antenna transceiver combination may be determined based on the two sensing measurement results (for example, a weighted sum).

Step 202: The first device obtains a target sensing measurement result based on the at least one sensing measurement result.

According to the sensing method in this embodiment of this application, the first device performs channel estimation on the received first signal, to obtain the at least one time-frequency domain channel matrix; obtains the at least one sensing measurement result based on the at least one of the time domain variance, the time domain standard deviation, or the time domain coefficient of variation of the at least one time-frequency domain channel matrix; and obtains the target sensing measurement result based on the at least one sensing measurement result. Then, based on the target sensing measurement result, information about a target object in a target environment such as a position and a velocity can be obtained, implementing a wireless sensing function in scenarios such as intrusion detection and trajectory tracking.

In some embodiments, that a first device obtains at least one sensing measurement result based on a time domain variance of at least one time-frequency domain channel matrix includes at least one of the following:
obtaining at least one sensing measurement result based on at least one of M variances corresponding to M subcarriers;
obtaining at least one sensing measurement result based on a weighted sum of M variances corresponding to M subcarriers;
obtaining at least one sensing measurement result based on a variance of M variances corresponding to M subcarriers;
obtaining at least one sensing measurement result based on a standard deviation of M variances corresponding to M subcarriers; or
obtaining at least one sensing measurement result based on a coefficient of variation of M variances corresponding to M subcarriers.

In some embodiments, that a first device obtains at least one sensing measurement result based on a time domain standard deviation of at least one time-frequency domain channel matrix includes at least one of the following:
obtaining at least one sensing measurement result based on at least one of M standard deviations corresponding to M subcarriers;
obtaining at least one sensing measurement result based on a weighted sum of M standard deviations corresponding to M subcarriers;
obtaining at least one sensing measurement result based on a variance of M standard deviations corresponding to M subcarriers;
obtaining at least one sensing measurement result based on a standard deviation of M standard deviations corresponding to M subcarriers; or
obtaining at least one sensing measurement result based on a coefficient of variation of M standard deviations corresponding to M subcarriers.

In some embodiments, that a first device obtains at least one sensing measurement result based on a time domain coefficient of variation of at least one time-frequency domain channel matrix includes at least one of the following:
obtaining at least one sensing measurement result based on at least one of M coefficients of variation corresponding to M subcarriers;
obtaining at least one sensing measurement result based on a weighted sum of M coefficients of variation corresponding to M subcarriers;
obtaining at least one sensing measurement result based on a variance of M coefficients of variation corresponding to M subcarriers;
obtaining at least one sensing measurement result based on a standard deviation of M coefficients of variation corresponding to M subcarriers; or
obtaining at least one sensing measurement result based on a coefficient of variation of M coefficients of variation corresponding to M subcarriers.

In some embodiments, an element in each time-frequency domain channel matrix includes one of the following:
a raw complex value of a frequency domain channel response corresponding to the antenna transceiver combination;
an amplitude of a frequency domain channel response corresponding to the antenna transceiver combination;
a phase of a frequency domain channel response corresponding to the antenna transceiver combination;
at least one of inphase data and quadrature data of a frequency domain channel response corresponding to the antenna transceiver combination;
a weighted sum of an amplitude and a phase of a frequency domain channel response corresponding to the antenna transceiver combination;
a weighted sum of inphase data and quadrature data of a frequency domain channel response corresponding to the antenna transceiver combination;
a raw complex value of a first result, where the first result is a quotient or a conjugate multiplication result of frequency domain channel responses corresponding to a first antenna transceiver combination and a second antenna transceiver combination;
an amplitude of the first result;
a phase of the first result;
at least one of inphase data and quadrature data of the first result;
a weighted sum of an amplitude and a phase of the first result; or
a weighted sum of inphase data and quadrature data of the first result.

In this embodiment of this application, one antenna transceiver combination may correspond to at least one time-frequency domain channel matrix. For example, a first antenna transceiver combination corresponds to a first time-frequency domain channel matrix, and a type of an element in the first time-frequency domain channel matrix is a raw complex value of a frequency domain channel response. In some embodiments, the first antenna transceiver combination corresponds to a second time-frequency domain channel matrix and a third time-frequency domain channel matrix. A type of an element in the second time-frequency domain channel matrix is an amplitude of a frequency domain channel response. A type of an element in the third time-frequency domain channel matrix is a phase of a frequency domain channel response. Herein, an amplitude and a phase of a frequency domain channel response are obtained based on a raw complex value of the frequency domain channel response.

In addition, in this embodiment of this application, elements in at least two time-frequency domain channel matrices corresponding to a same antenna transceiver combination are of different types, and elements in a time-frequency domain channel matrix are of a same type. Herein, a type of an element may be the raw complex value, amplitude, phase, or at least one of inphase data and quadrature data that is of a frequency domain channel response corresponding to an antenna transceiver combination, the amplitude or phase of a first result, or the like.

In some embodiments, that the first device obtains a target sensing measurement result based on the at least one sensing measurement result includes:
the first device uses at least one of the sensing measurement results as the target sensing measurement result; or
the first device calculates a weighted sum of at least two sensing measurement results, to obtain the target sensing measurement result.

In some embodiments, that the first device obtains a target sensing measurement result based on the at least one sensing measurement result includes at least one of the following:
selecting a sensing measurement result that meets a first threshold as the target sensing measurement result, where for example, a sensing measurement result greater than the first threshold is used as the target sensing measurement result, and in an intrusion detection scenario, if the target sensing measurement result meets the first threshold, it is determined that there is an intrusion in a target environment; using information about a relationship between a sensing measurement result and a first threshold as the target sensing measurement result, where the information about the relationship herein may indicate whether the sensing measurement result is greater than the first threshold, for example, if the sensing measurement result is greater than the first threshold, “1” is reported, whereas if the sensing measurement result is not greater than the first threshold, “0” is reported, and in this case, corresponding to an intrusion detection scenario, if “1” is reported, it indicates that there is an intrusion, whereas if “0” is reported, it indicates that there is no intrusion; in a case that a sensing measurement result meets a first threshold, using a difference between the sensing measurement result and the first threshold as the target sensing measurement result; or
in a case that a sensing measurement result meets a first threshold, using target information that is obtained based on the time-frequency domain channel matrix, as the target sensing measurement result (to be specific, when it is determined that there is an intrusion, a sensing measurement result required for tracking a trajectory of an intruder target is obtained based on reported target information), where
the target information includes at least one of the following:
doppler information of a target object;
a velocity of a target object;
coordinates (a position) of a target object;
a range between a target object and a signal transceiver device;
an angle between a target object and a signal transceiver device; or
a transmission-to-reception delay of the first signal.

In this embodiment of this application, the first device reports a sensing measurement result that meets the first threshold and/or information about a relationship between a sensing measurement result and the first threshold, effectively reducing a quantity of bits used for reporting. In addition, in the case that a sensing measurement result meets the first threshold, the first device reports a difference between the sensing measurement result and the first threshold and/or the target information to a second device, helping the second device adjust first indication information.

In some embodiments, the method in this embodiment of this application further includes:
the first device reports the target sensing measurement result or a result of quantizing the target sensing measurement result to the second device.

In this embodiment of this application, each antenna transceiver combination corresponds to one sensing measurement result. In a case that there are a plurality of antenna transceiver combinations, a plurality of sensing measurement results can be obtained. The first device may report at least one of the sensing measurement results to the second device, for example, select a maximum or minimum value for reporting. In some embodiments, the first device may calculate a weighted sum of the plurality of sensing measurement results and then report the weighted sum (that is, a target sensing measurement result) to the second device.

In addition, the first device reports a sensing measurement result that meets the first threshold and/or information about a relationship between a sensing measurement result and the first threshold, effectively reducing a quantity of bits used for reporting. Moreover, in the case that a sensing measurement result meets the first threshold, the first device reports a difference between the sensing measurement result and the first threshold and/or the target information to the second device, helping the second device subsequently adjust the first indication information.

Herein, the first device reports the target sensing measurement result that is obtained based on the at least one sensing measurement result to the second device, so that the second device can obtain information about a target object in a target environment such as a position and a velocity based on the target sensing measurement result.

In some embodiments, the target sensing measurement result further includes:
a time at which the first device receives the first signal;
a time at which the first device obtains the sensing measurement result or a time at which the first device obtains the target sensing measurement result; and
time unit information corresponding to the first signal.

Herein, the time unit information includes at least one of a frame number, a half-frame number, a slot number, or a symbol sequence number.

In some embodiments, before the first device obtains the at least one sensing measurement result based on the at least one of the time domain variance, standard deviation, or coefficient of variation of the at least one time-frequency domain channel matrix, the method further includes:
receiving the first indication information, where the first indication information indicates at least one of the following:
sensing requirement information, where the sensing requirement information corresponds to at least one of a sensing measurement item, a first threshold, configuration information of a first signal, and information about a time-frequency domain channel matrix, and herein, at least one of the sensing measurement item, the first threshold, the configuration information of the first signal, and the information about a time-frequency domain channel matrix can be indirectly obtained based on the sensing requirement information;
a sensing measurement item, where the sensing measurement item corresponds to a sensing measurement result, and the sensing measurement item indicates a sensing measurement result that is obtained through calculation performed by the first device based on the first signal and that corresponds to the sensing measurement item;
a first threshold;
configuration information of a first signal; or
information about a time-frequency domain channel matrix, where the information about a time-frequency domain channel matrix is associated with the configuration information of the first signal.

In this embodiment of this application, the sensing requirement information includes at least one of the following:
a sensing service type, such as intrusion detection, trajectory tracking, environment reconstruction, breathing detection, or action recognition;
a sensing area, such as geographic coordinates of a sensing area or a length, width, height, range, and angle range of a sensing area;
a sensing target type, such as a car, a motorcycle, or a pedestrian, indirectly indicating a range of a movement velocity of a sensing target and a power level of a reflection of a radio signal;
Quality of Service (QOS) for sensing/communication sensing integration, such as a service priority for sensing/communication sensing integration, a requirement for sensing resolution, a requirement for sensing precision or a sensing error, a requirement for a sensing delay budget, a requirement for a maximum sensing range, a requirement for continuous sensing, a requirement for a sensing updating frequency, a requirement for a detection probability, a requirement for a probability of false alarms, or a requirement for a probability of missed detection;
QoS for communication (for services of communication sensing integration), such as a communication delay budget or an erroneous reporting rate;
a quantity of sensing targets in a sensing area; or
a density of sensing targets in a sensing area.

In some embodiments, the information about a time-frequency domain channel matrix includes at least one of the following:
information about a time domain calculation window, including a quantity of time domain sampling points, a time domain sampling interval or a time domain sampling position, or a size of a time domain calculation window corresponding to a time-frequency domain channel matrix H, and a starting time or ending time of a time domain calculation window corresponding to H;
information about a frequency domain calculation window, including a quantity of frequency domain sampling points (a quantity of subcarriers), and a frequency domain sampling interval or a frequency domain sampling position;
a sliding step of a time domain calculation window of a time-frequency domain channel matrix, where the sliding step is used to indicate, for next calculation, a starting time and/or ending time of a time domain calculation window of a time-frequency domain channel matrix; or
information indicating a type of an element in a time-frequency domain channel matrix, such as a raw complex value type, an amplitude type, or a phase type.

In some embodiments, after the first device reports the target sensing measurement result or a result of quantizing the target sensing measurement result to the second device, the method further includes:
receiving second indication information, where the second indication information is sent in a case that the target sensing measurement result meets the first threshold, and the second indication information is used for adjusting a target parameter in the first indication information.

In some embodiments, the target parameter includes at least one of the following:
the sensing requirement information, for example, adding trajectory tracking and related requirement information;
the sensing measurement item, for example, adding a measurement item such as a delay, doppler information, an angle, a velocity, a range, or coordinates (a position);
the configuration information of the first signal, for example, increasing a time domain density of the first signal; or
the information about a time-frequency domain channel matrix, for example, increasing a quantity of time domain sampling points.

For example, for the intrusion detection scenario, if an intrusion of a target object into a target environment is detected based on a sensing measurement result, adjustment information for the first indication information may be sent, so that the first device measures the target object accordingly based on the adjustment information, to achieve closer tracking and detection.

It should be noted that in this embodiment of this application, the first device may determine whether a sensing measurement result meets the first threshold, and report information related to whether a sensing measurement result meets the first threshold to the second device, or the second device may determine, based on information reported by the first device, whether a sensing measurement result meets the first threshold. For example, the first device obtains three sensing measurement results based on a time-frequency domain channel matrix, processes the three sensing measurement results by using a preset algorithm to obtain a target sensing measurement result, determines whether the target sensing measurement result meets the first threshold, and sends, to the second device, indication information that indicates whether the target sensing measurement result meets the first threshold. In some embodiments, the second device may process the three sensing measurement results by using a preset algorithm to obtain a target sensing measurement result, and determine whether the target sensing measurement result meets the first threshold.

It should be noted that in this embodiment of this application, the first signal (which may also be referred to as a signal that is used for sensing) is transmitted and received in the following several manners. The first device may be a base station or User Equipment (UE). The second device may be a sensing network function device or a sensing network element in a core network, or may be a base station or UE.

Manner 1: A base station A transmits the signal that is used for sensing, and a base station B receives the signal that is used for sensing.

Manner 2: A base station transmits the signal that is used for sensing, and a core network device receives the signal that is used for sensing.

Manner 3: A base station transmits the signal that is used for sensing, and UE receives the signal that is used for sensing.

Manner 4: A core network device transmits the signal that is used for sensing, and a base station or UE receives the signal that is used for sensing.

Manner 5: A base station transmits and receives the signal that is used for sensing.

Manner 6: UE transmits and receives the signal that is used for sensing.

Manner 7: UE transmits the signal that is used for sensing, and a base station or a core network device receives the signal that is used for sensing.

In this embodiment of this application, there may be a plurality of signal transmitting devices and a plurality of signal receiving devices. The base station may be a TRP, a radio Access Point (AP), a relay device (Relay), a Reconfigurable Intelligent Surface (RIS), or the like.

In an embodiment of this application, the sensing method includes the following steps.

Step 1: The first device performs channel estimation after receiving a first signal. For example, the first device performs channel estimation by using the Least Squares (LS) method or the Minimum Mean Squared Error (MMSE) method, to obtain first channel matrices corresponding to different antenna transceiver combinations. Assuming that an antenna configuration includes one transmitting antenna and four receiving antennas, there are four antenna transceiver combinations, and therefore, there are four first channel matrices.

Step 2: Perform calculations on the first channel matrices based on information about a time-frequency domain channel matrix H in first indication information sent by a second device. For example, based on a time domain format and a frequency domain format of the matrix H (for example, including N time domain sampling points and M subcarriers), elements (that is, frequency domain channel responses corresponding to different subcarriers and time domain sampling points) in a channel estimation matrix are selected, to obtain an M×N second channel matrix. Likewise, assuming that an antenna configuration includes one transmitting antenna and four receiving antennas, there are four antenna transceiver combinations, and therefore, there are four second channel matrices. A quotient of second channel matrices corresponding to a first antenna transceiver combination and a second antenna transceiver combination is calculated, to obtain a time-frequency domain channel matrix. A total of six Hs can be obtained.

H1=H_tx1_rx1./H_tx1_rx2;

H2=H_tx 1_rx1./H_tx1_rx3;

H3=H_tx 1_rx1./H_tx1_rx4;

H4=H_tx 1_rx2./H_tx1_rx3;

H5=H_tx 1_rx2./H_tx 1_rx4;

H6=H_tx 1_rx3./H_tx1_rx4.

In the foregoing, “./” represents element-wise division. To be specific, each element in one matrix is divided by the corresponding element in another matrix. H_tx 1_rx1 represents the second channel matrix corresponding to the antenna transceiver combination that includes a transmitting antenna 1 and a receiving antenna 1, and so on.

In some embodiments, methods for determining a time domain calculation window and a frequency domain calculation window of the second channel matrix or the time-frequency domain channel matrix are described as follows.

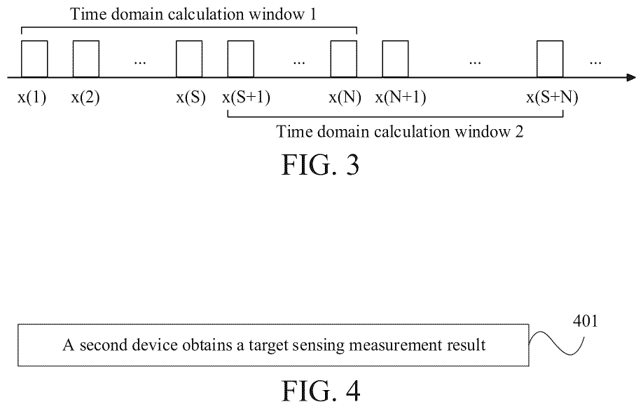

The time domain calculation window is determined as follows:
A time domain format of a first signal received by a first device or a time domain format of a corresponding channel estimation result is shown in FIG. 3. An interval between time domain sampling points of the first signal is associated with a sensing service requirement, for example, associated with a movement velocity of a detection target in an intrusion detection service, and at least meets: T≤1/|2·f_{dmax}|, where T represents a time interval of the first signal, and f_{dmax} represents a maximum doppler frequency shift caused by movement of a target. A size N of a time domain calculation window is associated with doppler resolution. For example, if duration of a time domain calculation window is T, corresponding doppler resolution is 1/T. A sliding step S of a time domain calculation window is associated with a sensing updating frequency. The parameters may be directly indicated in information about a time-frequency domain channel matrix H in first indication information that is sent by the second device to a first device, or may be determined by a first device based on sensing requirement information in first indication information that is sent by the second device to the first device.

The frequency domain calculation window is determined as follows:
From sampling points corresponding to all subcarriers in a received first signal, a first device selects sampling points corresponding to all or some of the subcarriers as a frequency domain calculation window. It is assumed that there are a total of M subcarriers. The sampling points may be contiguous, or may be non-contiguous, for example, are selected at equal intervals.

Step 3: Perform data preprocessing on the Hs, including at least one of the following.

Noise suppression: to suppress noise in target data. A method may be, for example, transform-domain noise suppression (for example, Discrete Fourier Transform (DFT) noise suppression), mean noise suppression, MMSE filtering noise suppression, Discrete Wavelet Transformation (DWT) noise suppression, or Principal Components Analysis (PCA) noise suppression.

Outlier removal: to remove outliers in target data. Outliers may be discarded or replaced. A method may be, for example, a Median Absolute Deviation (MAD) algorithm, the Hampel filter, a standard deviation method, or a percentile method.

Filtering: smooth filtering. For example, Savitzky-Golay filtering is used. In some embodiments, low-pass filtering, high-pass filtering, band-pass filtering, or band-stop filtering may be performed to filter out an unrelated frequency component.

Step 4: Normalize (that is, perform row-wise normalization) N time domain sample values corresponding to each subcarrier in the preprocessed time-frequency domain channel matrices, by using an example in which a variance is used as a first sensing measurement result.

A formula is as follows:

$${x}_{m}^{′} ( n ) = \frac{{x}_{m} ( n ) - min \{ {x}_{m} ( 1 ) , {x}_{m} ( 2 ) , … , {x}_{m} ( N ) \}}{max \{ {x}_{m} ( 1 ) , {x}_{m} ( 2 ) , … , {x}_{m} ( N ) \} - min \{ {x}_{m} ( 1 ) , {x}_{m} ( 2 ) , … , {x}_{m} ( N ) \}} .$$

In the formula, n=1, 2, . . . N represents an index of a time domain sampling point, and m=1,2, . . . M represents an index of a subcarrier. Then, a time domain variance is calculated for each subcarrier. A calculation formula is:

$${V}_{m} = \frac{1}{N - 1} {\sum }_{n = 1}^{N} {\vert {x}_{m}^{′} ( n ) - μ \vert}^{2} or {V}_{m} = \frac{1}{N} {\sum }_{n = 1}^{N} {\vert {x}_{m}^{′} ( n ) - μ \vert}^{2} ,$$

where m=1, 2, . . . M represents an index of a subcarrier. A total of M first variances (corresponding to M subcarriers respectively) can be obtained.

Step 5: Calculate a weighted sum of the M first variances to obtain a second variance. A method may be, for example, directly calculating a mean to obtain the second variance. The second variance corresponds to a sensing measurement result in this embodiment of this application.

Step 6: Corresponding to quotients of second channel matrices that correspond to different antenna transceiver combinations, a plurality of second variances can be obtained. For example, corresponding to H1 to H6, a total of six second variances can be obtained. A maximum or minimum value of the second variances is selected for reporting, or a weighted sum of the second variances is calculated and then reported.

For a case that a standard deviation or coefficient of variation is used as a first sensing measurement result, refer to the foregoing description. A coefficient of variation is calculated as follows: a ratio of a standard deviation to a mean.

Step 7: Select a time domain calculation window 2 based on the sliding step in step 2, and calculate a corresponding sensing measurement result. Perform similar operations to obtain sensing measurement results corresponding to different time domain calculation windows.

In this embodiment of this application, a receiving end performs calculations based on a received signal to obtain time domain characteristic information such as a variance, and implements a wireless sensing function such as intrusion detection based on the characteristic information.

As shown in FIG. 4, an embodiment of this application further provides a sensing method. The method includes the following step:
Step 401: A second device obtains a target sensing measurement result.

The target sensing measurement result is obtained by a first device based on at least one sensing measurement result, the sensing measurement result is obtained based on at least one of a time domain variance, standard deviation, or coefficient of variation of a time-frequency domain channel matrix, the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points.

Herein, the first signal may be a sensing signal or a communication signal. The communication signal can be used for sensing. The first signal may be a signal that is used for obtaining information about a target object such as a position, a range, and a velocity, or a signal that is used for detecting, tracking, identifying, and imaging a target object, event, environment, or the like.

The first device reports the target sensing measurement result that is obtained based on the at least one sensing measurement result to the second device, so that the second device can obtain information about a target object in a target environment such as a position and a velocity based on the target sensing measurement result.

According to the sensing method in this embodiment of this application, the first device performs channel estimation on the received first signal, to obtain the at least one time-frequency domain channel matrix; obtains the at least one sensing measurement result based on the at least one of the time domain variance, the time domain standard deviation, or the time domain coefficient of variation of the at least one time-frequency domain channel matrix; and obtains the target sensing measurement result based on the at least one sensing measurement result and reports the target sensing measurement result to the second device. In this way, by analyzing time domain characteristic information such as the variance, standard deviation, and/or coefficient of variation of the time-frequency domain channel matrix, the second device can obtain information about a target object in a target environment such as a position and a velocity, implementing a wireless sensing function in scenarios such as intrusion detection and trajectory tracking.

In some embodiments, before the second device obtains the target sensing measurement result, the method further includes:
sending first indication information, where the first indication information indicates at least one of the following:
sensing requirement information, where the sensing requirement information corresponds to at least one of a sensing measurement item, a first threshold, configuration information of a first signal, and information about a time-frequency domain channel matrix;
a sensing measurement item, where the sensing measurement item corresponds to a sensing measurement result;
a first threshold;
configuration information of a first signal; or
information about a time-frequency domain channel matrix.

In some embodiments, after the second device obtains the target sensing measurement result, the method further includes:
in a case that the target sensing measurement result meets the first threshold, sending second indication information, where the second indication information is used for adjusting a target parameter in the first indication information.

In some embodiments, the target parameter includes at least one of the following:
the sensing requirement information;
the sensing measurement item;
the configuration information of the first signal; or
the information about a time-frequency domain channel matrix.

In some embodiments, the information about a time-frequency domain channel matrix includes at least one of the following:
information about a time domain calculation window;
information about a frequency domain calculation window;
a sliding step of a time domain calculation window of a time-frequency domain channel matrix; or
information indicating a type of an element in a time-frequency domain channel matrix.

In some embodiments, the target sensing measurement result includes at least one of the following:
a sensing measurement result meeting the first threshold;
information about a relationship between a sensing measurement result and the first threshold;
a difference between the first threshold and a sensing measurement result that meets the first threshold; or
target information obtained based on the time-frequency domain channel matrix, where the target information is reported in a case that a sensing measurement result meets the first threshold, and
the target information includes at least one of the following:
doppler information of a target object;
a velocity of a target object;
coordinates of a target object;
a range between a target object and a signal transceiver device;
an angle between a target object and a signal transceiver device; or
a transmission-to-reception delay of the first signal.

According to the sensing method in this embodiment of this application, the first device performs channel estimation on the received first signal, to obtain the at least one time-frequency domain channel matrix; obtains the at least one sensing measurement result based on the at least one of the time domain variance, the time domain standard deviation, or the time domain coefficient of variation of the at least one time-frequency domain channel matrix; and obtains the target sensing measurement result based on the at least one sensing measurement result and reports the target sensing measurement result to the second device. In this way, by analyzing time domain characteristic information such as the variance, standard deviation, and/or coefficient of variation of the time-frequency domain channel matrix, the second device can obtain information about a target object in a target environment such as a position and a velocity, implementing a wireless sensing function in scenarios such as intrusion detection and trajectory tracking.

The sensing methods provided in embodiments of this application may be performed by sensing apparatuses. In embodiments of this application, sensing apparatuses provided in embodiments of this application are described by using examples in which sensing apparatuses perform the sensing methods.

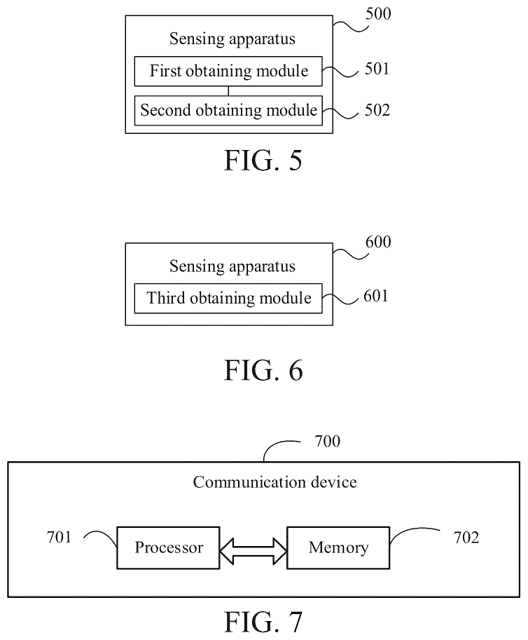

As shown in FIG. 5, an embodiment of this application provides a sensing apparatus 500, used in a first device. The apparatus includes:
a first obtaining module 501, configured to obtain at least one sensing measurement result based on at least one of a time domain variance, standard deviation, and coefficient of variation of at least one me-frequency domain channel matrix, where the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the sensing apparatus, the time-frequency domain channel matrix is an M×N or N×M matrix, M represents a quantity of frequency domain sampling points, and N represents a quantity of time domain sampling points; and
a second obtaining module 502, configured to obtain a target sensing measurement result based on the at least one sensing measurement result.

In some embodiments, the first obtaining module is configured to perform at least one of the following:
obtaining at least one sensing measurement result based on at least one of M variances corresponding to M subcarriers;
obtaining at least one sensing measurement result based on a weighted sum of M variances corresponding to M subcarriers;
obtaining at least one sensing measurement result based on a variance of M variances corresponding to M subcarriers;
obtaining at least one sensing measurement result based on a standard deviation of M variances corresponding to M subcarriers; or
obtaining at least one sensing measurement result based on a coefficient of variation of M variances corresponding to M subcarriers.

In some embodiments, the first obtaining module is configured to perform at least one of the following: obtaining at least one sensing measurement result based on at least one of M standard deviations corresponding to M subcarriers;
obtaining at least one sensing measurement result based on a weighted sum of M standard deviations corresponding to M subcarriers;
obtaining at least one sensing measurement result based on a variance of M standard deviations corresponding to M subcarriers;
obtaining at least one sensing measurement result based on a standard deviation of M standard deviations corresponding to M subcarriers; or
obtaining at least one sensing measurement result based on a coefficient of variation of M standard deviations corresponding to M subcarriers.

In some embodiments, the first obtaining module is configured to perform at least one of the following: obtaining at least one sensing measurement result based on at least one of M coefficients of variation corresponding to M subcarriers;
obtaining at least one sensing measurement result based on a weighted sum of M coefficients of variation corresponding to M subcarriers;
obtaining at least one sensing measurement result based on a variance of M coefficients of variation corresponding to M subcarriers;
obtaining at least one sensing measurement result based on a standard deviation of M coefficients of variation corresponding to M subcarriers; or
obtaining at least one sensing measurement result based on a coefficient of variation of M coefficients of variation corresponding to M subcarriers.

In some embodiments, an element in each time-frequency domain channel matrix includes one of the following:
a raw complex value of a frequency domain channel response corresponding to the antenna transceiver combination;
an amplitude of a frequency domain channel response corresponding to the antenna transceiver combination;
a phase of a frequency domain channel response corresponding to the antenna transceiver combination;
at least one of inphase data and quadrature data of a frequency domain channel response corresponding to the antenna transceiver combination;
a weighted sum of an amplitude and a phase of a frequency domain channel response corresponding to the antenna transceiver combination;
a weighted sum of inphase data and quadrature data of a frequency domain channel response corresponding to the antenna transceiver combination;
a raw complex value of a first result, where the first result is a quotient or a conjugate multiplication result of frequency domain channel responses corresponding to a first antenna transceiver combination and a second antenna transceiver combination;
an amplitude of the first result;
a phase of the first result;
at least one of inphase data and quadrature data of the first result;
a weighted sum of an amplitude and a phase of the first result; or
a weighted sum of inphase data and quadrature data of the first result.

In some embodiments, the second obtaining module is configured to: use at least one of the sensing measurement results or a quantized value of at least one of the sensing measurement results as the target sensing measurement result; or
calculate a weighted sum of at least two sensing measurement results, to obtain the target sensing measurement result.

In some embodiments, the second obtaining module is configured to perform at least one of the following:
selecting a sensing measurement result that meets a first threshold as the target sensing measurement result;
using information about a relationship between a sensing measurement result and a first threshold as the target sensing measurement result;
in a case that a sensing measurement result meets a first threshold, using a difference between the sensing measurement result and the first threshold as the target sensing measurement result; or
in a case that a sensing measurement result meets a first threshold, using target information that is obtained based on the time-frequency domain channel matrix, as the target sensing measurement result, where
the target information includes at least one of the following:
doppler information of a target object;
a velocity of a target object;
coordinates of a target object;
a range between a target object and a signal transceiver device;
an angle between a target object and a signal transceiver device; or
a transmission-to-reception delay of the first signal.

In some embodiments, the apparatus in this embodiment of this application is further configured to:
report the target sensing measurement result or a result of quantizing the target sensing measurement result to a second device.

In some embodiments, the target sensing measurement result further includes:
a time at which the first device receives the first signal;
a time at which the first device obtains the sensing measurement result or a time at which the first device obtains the target sensing measurement result; and
time unit information corresponding to the first signal.

In some embodiments, the apparatus further includes
a first receiving module, configured to receive first indication information before the first obtaining module obtains the at least one sensing measurement result, where the first indication information indicates at least one of the following:
sensing requirement information, where the sensing requirement information corresponds to at least one of a sensing measurement item, a first threshold, configuration information of a first signal, and information about a time-frequency domain channel matrix;
a sensing measurement item, where the sensing measurement item corresponds to a sensing measurement result;
a first threshold;
configuration information of a first signal; or
information about a time-frequency domain channel matrix.

In some embodiments, the apparatus further includes
a second receiving module, configured to receive second indication information after a reporting module reports the target sensing measurement result or the result of quantizing the target sensing measurement result to the second device, where the second indication information is sent in a case that the target sensing measurement result meets the first threshold, and the second indication information is used for adjusting a target parameter in the first indication information.

In some embodiments, the target parameter includes at least one of the following:
the sensing requirement information;
the sensing measurement item;
the configuration information of the first signal; or
the information about a time-frequency domain channel matrix.

In some embodiments, the information about a me-frequency domain channel matrix includes at least one of the following:
information about a time domain calculation window;
information about a frequency domain calculation window;
a sliding step of a time domain calculation window of a time-frequency domain channel matrix; or
information indicating a type of an element in a time-frequency domain channel matrix.

In this embodiment of this application, the first device performs channel estimation on the received first signal, to obtain the at least one time-frequency domain channel matrix; obtains the at least one sensing measurement result based on the at least one of the time domain variance, the time domain standard deviation, and the time domain coefficient of variation of the at least one time-frequency domain channel matrix; and obtains the target sensing measurement result based on the at least one sensing measurement result. Then, based on the target sensing measurement result, information about a target object in a target environment such as a position and a velocity can be obtained, implementing a wireless sensing function in scenarios such as intrusion detection and trajectory tracking.

As shown in FIG. 6, an embodiment of this application further provides a sensing apparatus 600, used in a second device. The apparatus includes:
a third obtaining module 601, configured to obtain a target sensing measurement result, where
the target sensing measurement result is obtained by a first device based on at least one sensing measurement result, the sensing measurement result is obtained based on at least one of a time domain variance, standard deviation, and coefficient of variation of a time-frequency domain channel matrix, the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points.

In some embodiments, the apparatus further includes
a first sending module, configured to send first indication information before the third obtaining module obtains the target sensing measurement result, where the first indication information indicates at least one of the following:
sensing requirement information, where the sensing requirement information corresponds to at least one of a sensing measurement item, a first threshold, configuration information of a first signal, and information about a time-frequency domain channel matrix;
a sensing measurement item, where the sensing measurement item corresponds to a sensing measurement result;
a first threshold;
configuration information of a first signal; or
information about a time-frequency domain channel matrix.

In some embodiments, the apparatus further includes
a second sending module, configured to send second indication information in a case that the target sensing measurement result meets the first threshold after the third obtaining module obtains the target sensing measurement result, where the second indication information is used for adjusting a target parameter in the first indication information.

In some embodiments, the target parameter includes at least one of the following:
the sensing requirement information;
the sensing measurement item;
the configuration information of the first signal; or
the information about a time-frequency domain channel matrix.

In some embodiments, the information about a time-frequency domain channel matrix includes at least one of the following:
information about a time domain calculation window;
information about a frequency domain calculation window;
a sliding step of a time domain calculation window of a time-frequency domain channel matrix; or
information indicating a type of an element in a time-frequency domain channel matrix.

In some embodiments, the target sensing measurement result includes at least one of the following:
a sensing measurement result meeting the first threshold;
information about a relationship between a sensing measurement result and the first threshold;
a difference between the first threshold and a sensing measurement result that meets the first threshold; or
target information obtained based on the time-frequency domain channel matrix, where the target information is reported in a case that a sensing measurement result meets the first threshold, and
the target information includes at least one of the following:
doppler information of a target object;
a velocity of a target object;
coordinates of a target object;
a range between a target object and a signal transceiver device;
an angle between a target object and a signal transceiver device; or
a transmission-to-reception delay of the first signal.

In this embodiment of this application, the first device performs channel estimation on the received first signal, to obtain the at least one time-frequency domain channel matrix; obtains the at least one sensing measurement result based on the at least one of the time domain variance, the time domain standard deviation, and the time domain coefficient of variation of the at least one time-frequency domain channel matrix; and obtains the target sensing measurement result based on the at least one sensing measurement result and reports the target sensing measurement result to the second device. In this way, by analyzing time domain characteristic information such as the variance, standard deviation, and/or coefficient of variation of the time-frequency domain channel matrix, the second device can obtain information about a target object in a target environment such as a position and a velocity, implementing a wireless sensing function in scenarios such as intrusion detection and trajectory tracking.

The sensing apparatus in embodiments of this application may be an electronic device, for example, an electronic device with an operating system, or may be a component in an electronic device, for example, an integrated circuit or a chip. The electronic device may be a terminal, or may be another device other than a terminal. For example, a terminal may be of but is not limited to the types of the terminal 11 listed above, and another device may be a server, a Network Attached Storage (NAS), or the like. This is not specifically limited in embodiments of this application.

The sensing apparatus provided in embodiments of this application can perform the procedures implemented in the method embodiment in FIG. 2 and FIG. 3 and achieve same technical effects. To avoid repetition, details are not described herein again.

As shown in FIG. 7, an embodiment of this application further provides a communication device 700, including a processor 701 and a memory 702. The memory 702 stores a program or instructions that can be run on the processor 701. For example, in a case that the communication device 700 is a first device, when the program or instructions are executed by the processor 701, the steps in the method embodiment on the first-device side are performed, and same technical effects can be achieved. In a case that the communication device 700 is a second device, when the program or instructions are executed by the processor 701, the steps in the method embodiment on the second-device side are performed, and same technical effects can be achieved. To avoid repetition, details are not described herein again.

An embodiment of this application further provides a first device, including a processor and a communication interface. The processor is configured to: obtain at least one sensing measurement result based on at least one of a time domain variance, standard deviation, and coefficient of variation of at least one time-frequency domain channel matrix, where the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points; and obtain, by the first device, a target sensing measurement result based on the at least one sensing measurement result. This embodiment corresponds to the method embodiment on the first-device side. The implementation procedures and implementations in the method embodiment may all be applicable to this embodiment, and same technical effects can be achieved.

An embodiment of this application further provides a second device, including a processor and a communication interface. The communication interface is configured to obtain a target sensing measurement result, where

the target sensing measurement result is obtained by a first device based on at least one sensing measurement result, the sensing measurement result is obtained based on at least one of a time domain variance, standard deviation, and coefficient of variation of a time-frequency domain channel matrix, the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points. This second-device embodiment corresponds to the method embodiment on the second-device side. The implementation procedures and implementations in the method embodiment may all be applicable to this second-device embodiment, and same technical effects can be achieved.

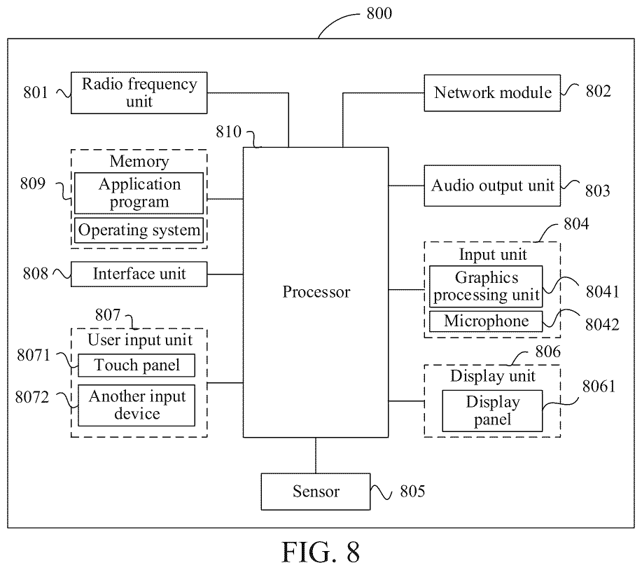

FIG. 8 is a diagram of a hardware structure of a first device or a second device (which is a terminal) that implements an embodiment of this application.

The terminal 800 includes but is not limited to at least some of a radio frequency unit 801, a network module 802, an audio output unit 803, an input unit 804, a sensor 805, a display unit 806, a user input unit 807, an interface unit 808, a memory 809, a processor 810, and the like.

Persons skilled in the art may understand that the terminal 800 may further include a power supply (such as a battery) that supplies power to the components. The power supply may be logically connected to the processor 810 by a power management system, implementing functions such as charging, discharging, and power consumption management by using the power management system. The structure of the terminal shown in FIG. 8 does not constitute a limitation on the terminal. A terminal may include more or fewer components than those shown in the figure, or combine some components, or have different component arrangements. Details are not described herein.

It should be understood that the input unit 804 may include a Graphics Processing Unit (GPU) 8041 and a microphone 8042 in this embodiment of this application. The graphics processing unit 8041 processes image data of still pictures or videos that are obtained by image capture apparatuses (for example, cameras) in video capture mode or image capture mode. The display unit 806 may include a display panel 8061. The display panel 8061 may be configured in the form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include, but is not limited to, a physical keyboard, a functional button (such as a volume control button or a switch button), a trackball, a mouse, or a joystick. Details are not described herein.

In this embodiment of this application, after receiving downlink data from a network-side device, the radio frequency unit 801 may transmit the data to the processor 810 for processing. In addition, the radio frequency unit 801 may send uplink data to a network-side device. Usually, the radio frequency unit 801 includes, but is not limited to, an antenna, an amplifier, a transceiver, a coupler, a low noise amplifier, a duplexer, and the like.

The memory 809 may be configured to store software programs or instructions, and various data. The memory 809 may mainly include a first storage area in which programs or instructions are stored and a second storage area in which data is stored. In the first storage area, the following may be stored: an operating system, application programs or instructions required by at least one function (for example, a sound playing function and an image display function), and the like. In addition, the memory 809 may include a volatile memory or a non-volatile memory, or may include both a volatile memory and a non-volatile memory. A non-volatile memory may be a Read-Only Memory (ROM), a Programmable ROM (PROM), an Erasable PROM (EPROM), an Electrically EPROM (EEPROM), or a flash memory. A volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), or a Direct Rambus RAM (DRRAM). The memory 809 in this embodiment of this application includes, but is not limited to, these memories and any other suitable types of memories.

The processor 810 may include one or more processing units. In some embodiments, an application processor and a modem processor integrate with the processor 810. The application processor primarily handles operations related to an operating system, user interfaces, application programs, and the like. The modem processor primarily processes wireless communication signals, for example, a baseband processor. It may be understood that the modem processor may not be integrated into the processor 810.

In an embodiment of this application, the processor 810 is configured to: obtain at least one sensing measurement result based on at least one of a time domain variance, standard deviation, and coefficient of variation of at least one time-frequency domain channel matrix, where the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points; and obtain a target sensing measurement result based on the at least one sensing measurement result.

In some embodiments, the processor 810 is further configured to perform at least one of the following: obtaining at least one sensing measurement result based on at least one of M variances corresponding to M subcarriers;
obtaining at least one sensing measurement result based on a weighted sum of M variances corresponding to M subcarriers;
obtaining at least one sensing measurement result based on a variance of M variances corresponding to M subcarriers;
obtaining at least one sensing measurement result based on a standard deviation of M variances corresponding to M subcarriers; or obtaining at least one sensing measurement result based on a coefficient of variation of M variances corresponding to M subcarriers.
In some embodiments, the processor 810 is further configured to perform at least one of the following: obtaining at least one sensing measurement result based on at least one of M standard deviations corresponding to M subcarriers;
obtaining at least one sensing measurement result based on a weighted sum of M standard deviations corresponding to M subcarriers;
obtaining at least one sensing measurement result based on a variance of M standard deviations corresponding to M subcarriers;
obtaining at least one sensing measurement result based on a standard deviation of M standard deviations corresponding to M subcarriers; or
obtaining at least one sensing measurement result based on a coefficient of variation of M standard deviations corresponding to M subcarriers.

In some embodiments, the processor 810 is further configured to perform at least one of the following: obtaining at least one sensing measurement result based on at least one of M coefficients of variation corresponding to M subcarriers;
obtaining at least one sensing measurement result based on a weighted sum of M coefficients of variation corresponding to M subcarriers;
obtaining at least one sensing measurement result based on a variance of M coefficients of variation corresponding to M subcarriers;
obtaining at least one sensing measurement result based on a standard deviation of M coefficients of variation corresponding to M subcarriers; or
obtaining at least one sensing measurement result based on a coefficient of variation of M coefficients of variation corresponding to M subcarriers.

In some embodiments, an element in each time-frequency domain channel matrix includes one of the following:
a raw complex value of a frequency domain channel response corresponding to the antenna transceiver combination;
an amplitude of a frequency domain channel response corresponding to the antenna transceiver combination;
a phase of a frequency domain channel response corresponding to the antenna transceiver combination;
at least one of inphase data and quadrature data of a frequency domain channel response corresponding to the antenna transceiver combination;
a weighted sum of an amplitude and a phase of a frequency domain channel response corresponding to the antenna transceiver combination;
a weighted sum of inphase data and quadrature data of a frequency domain channel response corresponding to the antenna transceiver combination;
a raw complex value of a first result, where the first result is a quotient or a conjugate multiplication result of frequency domain channel responses corresponding to a first antenna transceiver combination and a second antenna transceiver combination;
an amplitude of the first result;
a phase of the first result;
at least one of inphase data and quadrature data of the first result;
a weighted sum of an amplitude and a phase of the first result; or
a weighted sum of inphase data and quadrature data of the first result.

In some embodiments, the processor 810 is configured to: use at least one of the sensing measurement results or a quantized value of at least one of the sensing measurement results as the target sensing measurement result; or
calculate, by the first device, a weighted sum of at least two sensing measurement results, to obtain the target sensing measurement result.

In some embodiments, the processor 810 is configured to perform at least one of the following:
selecting a sensing measurement result that meets a first threshold as the target sensing measurement result;
using information about a relationship between a sensing measurement result and a first threshold as the target sensing measurement result;
in a case that a sensing measurement result meets a first threshold, using a difference between the sensing measurement result and the first threshold as the target sensing measurement result; or
in a case that a sensing measurement result meets a first threshold, using target information that is obtained based on the time-frequency domain channel matrix, as the target sensing measurement result, where
the target information includes at least one of the following:
doppler information of a target object;
a velocity of a target object;
coordinates of a target object;
a range between a target object and a signal transceiver device;
an angle between a target object and a signal transceiver device; or
a transmission-to-reception delay of the first signal.

In some embodiments, the radio frequency unit 801 is configured to: report the target sensing measurement result or a result of quantizing the target sensing measurement result to the second device.

In some embodiments, the target sensing measurement result further includes:
a time at which the first device receives the first signal;
a time at which the first device obtains the sensing measurement result or a time at which the first device obtains the target sensing measurement result; and
time unit information corresponding to the first signal.

In some embodiments, the radio frequency unit 801 is further configured to:
receive first indication information, where the first indication information indicates at least one of the following:
sensing requirement information, where the sensing requirement information corresponds to at least one of a sensing measurement item, a first threshold, configuration information of a first signal, and information about a time-frequency domain channel matrix;
a sensing measurement item, where the sensing measurement item corresponds to a sensing measurement result;
a first threshold;
configuration information of a first signal; or
information about a time-frequency domain channel matrix.

In some embodiments, the radio frequency unit 801 is further configured to:
receive second indication information, where the second indication information is sent in a case that the target sensing measurement result meets the first threshold, and the second indication information is used for adjusting a target parameter in the first indication information.

In some embodiments, the target parameter includes at least one of the following:
the sensing requirement information;
the sensing measurement item;
the configuration information of the first signal; or
the information about a time-frequency domain channel matrix.

In some embodiments, the information about a time-frequency domain channel matrix includes at least one of the following:
information about a time domain calculation window;
information about a frequency domain calculation window;
a sliding step of a time domain calculation window of a time-frequency domain channel matrix; or
information indicating a type of an element in a time-frequency domain channel matrix.

In this embodiment of this application, the first device performs channel estimation on the received first signal, to obtain the at least one time-frequency domain channel matrix; obtains the at least one sensing measurement result based on the at least one of the time domain variance, the time domain standard deviation, and the time domain coefficient of variation of the at least one time-frequency domain channel matrix; and obtains the target sensing measurement result based on the at least one sensing measurement result. Then, based on the target sensing measurement result, information about a target object in a target environment such as a position and a velocity can be obtained, implementing a wireless sensing function in scenarios such as intrusion detection and trajectory tracking.

In another embodiment of this application, the radio frequency unit 801 is configured to obtain a target sensing measurement result, where
the target sensing measurement result is obtained by the first device based on at least one sensing measurement result, the sensing measurement result is obtained based on at least one of a time domain variance, standard deviation, and coefficient of variation of a time-frequency domain channel matrix, the time-frequency domain channel matrix includes information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points.

In some embodiments, the radio frequency unit 801 is further configured to:
send first indication information, where the first indication information indicates at least one of the following:
sensing requirement information, where the sensing requirement information corresponds to at least one of a sensing measurement item, a first threshold, configuration information of a first signal, and information about a time-frequency domain channel matrix;
a sensing measurement item, where the sensing measurement item corresponds to a sensing measurement result;
a first threshold;
configuration information of a first signal; or
information about a time-frequency domain channel matrix.

In some embodiments, the radio frequency unit 801 is further configured to:
send second indication information in a case that the target sensing measurement result meets the first threshold, where the second indication information is used for adjusting a target parameter in the first indication information.

In some embodiments, the target parameter includes at least one of the following:
the sensing requirement information;
the sensing measurement item;
the configuration information of the first signal; or
the information about a time-frequency domain channel matrix.

In some embodiments, the information about a time-frequency domain channel matrix includes at least one of the following:
information about a time domain calculation window;
information about a frequency domain calculation window;
a sliding step of a time domain calculation window of a time-frequency domain channel matrix; or
information indicating a type of an element in a time-frequency domain channel matrix.

In some embodiments, the target sensing measurement result includes at least one of the following:
a sensing measurement result meeting the first threshold;
information about a relationship between a sensing measurement result and the first threshold;
a difference between the first threshold and a sensing measurement result that meets the first threshold; or
target information obtained based on the time-frequency domain channel matrix, where the target information is reported in a case that a sensing measurement result meets the first threshold, and
the target information includes at least one of the following:
doppler information of a target object;
a velocity of a target object;
coordinates of a target object;
a range between a target object and a signal transceiver device;
an angle between a target object and a signal transceiver device; or
a transmission-to-reception delay of the first signal.

In this embodiment of this application, the first device performs channel estimation on the received first signal, to obtain the at least one time-frequency domain channel matrix; obtains the at least one sensing measurement result based on the at least one of the time domain variance, the time domain standard deviation, and the time domain coefficient of variation of the at least one time-frequency domain channel matrix; and obtains the target sensing measurement result based on the at least one sensing measurement result and reports the target sensing measurement result to the second device. In this way, by analyzing time domain characteristic information such as the variance, standard deviation, and/or coefficient of variation of the time-frequency domain channel matrix, the second device can obtain information about a target object in a target environment such as a position and a velocity, implementing a wireless sensing function in scenarios such as intrusion detection and trajectory tracking.

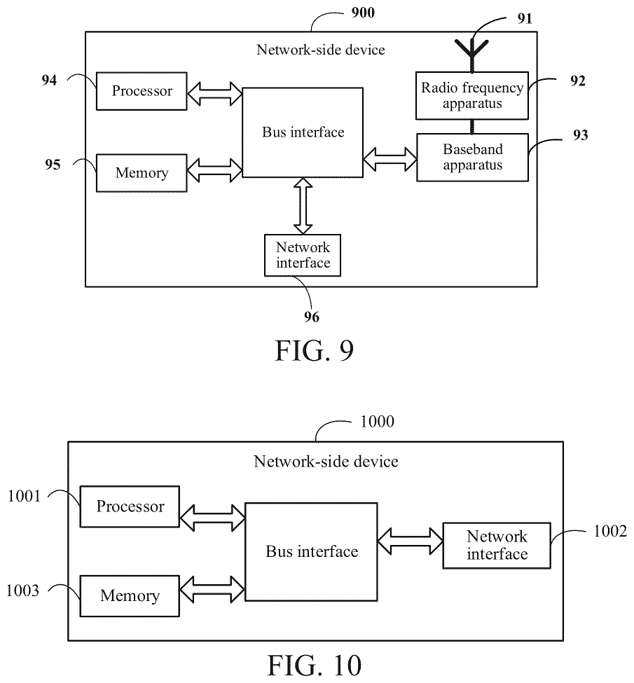

An embodiment of this application further provides a network-side device (which may be a first device or a second device). As shown in FIG. 9, the network-side device 900 includes: an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information by using the antenna 91 and sends the received information to the baseband apparatus 93 for processing. In a downlink direction, the baseband apparatus 93 processes to-be-sent information and sends processed information to the radio frequency apparatus 92. The radio frequency apparatus 92 receives and processes the information, and sends out processed information by using the antenna 91.

The method performed by the first device or the second device in the foregoing embodiments may be implemented in the baseband apparatus 93. The baseband apparatus 93 includes a baseband processor.

The baseband apparatus 93 may include, for example, at least one baseband board. A plurality of chips are disposed on the baseband board. As shown in FIG. 9, one of the chips, for example, a baseband processor, is connected to the memory 95 by using a bus interface, to invoke a program in the memory 95 to perform the network device operations shown in the foregoing method embodiments.

The network-side device may further include a network interface 96. The interface is, for example, a common public radio interface (CPRI).

The network-side device 900 in this embodiment of this application further includes instructions or a program that are or is stored in the memory 95 and can be run on the processor 94. The processor 94 invokes the instructions or program in the memory 95 to perform the method performed by the modules shown in FIG. 5 or FIG. 6, and achieves same technical effects. To avoid repetition, details are not described herein again.

An embodiment of this application further provides a network-side device (which may be a first device or a second device). As shown in FIG. 10, the network-side device 1000 includes: a processor 1001, a network interface 1002, and a memory 1003. The network interface 1002 is, for example, a common public radio interface (CPRI).

The network-side device 1000 in this embodiment of this application further includes instructions or a program that are or is stored in the memory 1003 and can be run on the processor 1001. The processor 1001 invokes the instructions or program in the memory 1003 to perform the method performed by the modules shown in FIG. 5 or FIG. 6, and achieves same technical effects. To avoid repetition, details are not described herein again.

An embodiment of this application further provides a readable storage medium. The readable storage medium stores a program or instructions. When the program or instructions are executed by a processor, the procedures in the foregoing sensing method embodiments are performed, and same technical effects can be achieved. To avoid repetition, details are not described herein again.

The processor is the processor in the terminal in the foregoing embodiment. The readable storage medium includes a computer-readable storage medium, for example, a computer read-only memory ROM, a random access memory RAM, a magnetic disk, or a compact disc.

An embodiment of this application further provides a chip. The chip includes a processor and a communication interface. The communication interface is coupled to the processor. The processor is configured to run a program or instructions to implement the procedures in the foregoing sensing method embodiments, and can achieve same technical effects. To avoid repetition, details are not described herein again.

It should be understood that the chip mentioned in this embodiment of this application may also be referred to as a system-level chip, a system chip, a chip system, a system-on-chip chip, or the like.

An embodiment of this application further provides a computer program/program product. The computer program/program product is stored in a storage medium. The computer program/program product is executed by at least one processor to implement the procedures in the foregoing sensing method embodiments, and same technical effects can be achieved. To avoid repetition, details are not described herein again.

An embodiment of this application further provides a sensing system, including a first device and a second device. The first device may be configured to perform the steps in the sensing method on the first-device side described above. The second device may be configured to perform the steps in the sensing method on the second-device side described above.

It should be noted that the term “include”, “comprise”, or any other variant thereof in this specification is intended to cover a non-exclusive inclusion, so that a process, a method, an object, or an apparatus that includes a list of elements not only includes those elements but also includes other elements that are not explicitly listed, or further includes elements inherent to such process, method, object, or apparatus. In absence of more constraints, an element preceded by “includes a . . . ” does not preclude existence of other identical elements in the process, method, object, or apparatus that includes the clement. In addition, it should be noted that in the scope of the methods and apparatuses in implementations of this application, an order in which functions are performed is not limited to the shown or discussed order, and may further include an order in which the functions are substantially performed at the same time or a reverse order, depending on the functions related to. For example, the methods described may be performed in different orders than the described orders, and steps may be added, omitted, or combined. In addition, features described with reference to some examples may be combined in other examples.

Based on the descriptions in the foregoing implementations, persons skilled in the art may clearly learn that the methods in the foregoing embodiments may be implemented by a combination of software and a mandatory common hardware platform. In some embodiments, the methods may be implemented by hardware. However, the former is a better implementation in many cases. Based on such an understanding, the technical solutions of this application essentially or the part contributing to the conventional technology may be implemented in a form of a computer software product. The computer software product is stored in a storage medium (for example, a ROM/RAM, a magnetic disk, or a compact disc), and includes several instructions for indicating a terminal (which may be a mobile phone, a computer, a server, an air conditioner, a network device, or the like) to perform the methods described in embodiments of this application.

Embodiments of this application are described above with reference to the accompanying drawings. However, this application is not limited to the specific implementations described above, and the specific implementations described above are merely illustrative but not restrictive. Under inspiration of this application, persons of ordinary skill in the art may also make many variations without departing from the purpose of this application and the protection scope of the claims, and such variations all fall within the protection scope of this application.

What is claimed is:

1. A sensing method, comprising:
obtaining, by a first device, at least one sensing measurement result based on at least one of a time domain variance, standard deviation, or coefficient of variation of at least one time-frequency domain channel matrix, wherein the time-frequency domain channel matrix comprises information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points; and
obtaining, by the first device, a target sensing measurement result based on the at least one sensing measurement result.

2. The sensing method according to claim 1, wherein the obtaining, by a first device, at least one sensing measurement result based on a time domain variance of at least one time-frequency domain channel matrix comprises at least one of the following:
obtaining, by the first device, at least one sensing measurement result based on at least one of M variances corresponding to M subcarriers;
obtaining, by the first device, at least one sensing measurement result based on a weighted sum of M variances corresponding to M subcarriers;
obtaining, by the first device, at least one sensing measurement result based on a variance of M variances corresponding to M subcarriers;
obtaining, by the first device, at least one sensing measurement result based on a standard deviation of M variances corresponding to M subcarriers; or
obtaining, by the first device, at least one sensing measurement result based on a coefficient of variation of M variances corresponding to M subcarriers.

3. The sensing method according to claim 1, wherein the obtaining, by a first device, at least one sensing measurement result based on a time domain standard deviation of at least one time-frequency domain channel matrix comprises at least one of the following:
obtaining, by the first device, at least one sensing measurement result based on at least one of M standard deviations corresponding to M subcarriers;
obtaining, by the first device, at least one sensing measurement result based on a weighted sum of M standard deviations corresponding to M subcarriers;
obtaining, by the first device, at least one sensing measurement result based on a variance of M standard deviations corresponding to M subcarriers;
obtaining, by the first device, at least one sensing measurement result based on a standard deviation of M standard deviations corresponding to M subcarriers; or
obtaining, by the first device, at least one sensing measurement result based on a coefficient of variation of M standard deviations corresponding to M subcarriers.

4. The sensing method according to claim 1, wherein the obtaining, by a first device, at least one sensing measurement result based on a time domain coefficient of variation of at least one time-frequency domain channel matrix comprises at least one of the following:
obtaining, by the first device, at least one sensing measurement result based on at least one of M coefficients of variation corresponding to M subcarriers;
obtaining, by the first device, at least one sensing measurement result based on a weighted sum of M coefficients of variation corresponding to M subcarriers;
obtaining, by the first device, at least one sensing measurement result based on a variance of M coefficients of variation corresponding to M subcarriers;
obtaining, by the first device, at least one sensing measurement result based on a standard deviation of M coefficients of variation corresponding to M subcarriers; or
obtaining, by the first device, at least one sensing measurement result based on a coefficient of variation of M coefficients of variation corresponding to M subcarriers.

5. The sensing method according to claim 1, wherein an element in each time-frequency domain channel matrix comprises one of the following:
a raw complex value of a frequency domain channel response corresponding to the antenna transceiver combination;
an amplitude of a frequency domain channel response corresponding to the antenna transceiver combination;
a phase of a frequency domain channel response corresponding to the antenna transceiver combination;
at least one of inphase data and quadrature data of a frequency domain channel response corresponding to the antenna transceiver combination;
a weighted sum of an amplitude and a phase of a frequency domain channel response corresponding to the antenna transceiver combination;
a weighted sum of inphase data and quadrature data of a frequency domain channel response corresponding to the antenna transceiver combination;
a raw complex value of a first result, wherein the first result is a quotient or a conjugate multiplication result of frequency domain channel responses corresponding to a first antenna transceiver combination and a second antenna transceiver combination;
an amplitude of the first result;
a phase of the first result;
at least one of inphase data and quadrature data of the first result;
a weighted sum of an amplitude and a phase of the first result; or
a weighted sum of inphase data and quadrature data of the first result.

6. The sensing method according to claim 1, wherein the obtaining, by the first device, a target sensing measurement result based on the at least one sensing measurement result comprises:
using, by the first device, at least one of the sensing measurement results as the target sensing measurement result; or
calculating, by the first device, a weighted sum of at least two sensing measurement results, to obtain the target sensing measurement result.

7. The sensing method according to claim 1, wherein the obtaining, by the first device, a target sensing measurement result based on the at least one sensing measurement result comprises at least one of the following:
selecting a sensing measurement result that meets a first threshold as the target sensing measurement result;
using information about a relationship between a sensing measurement result and a first threshold as the target sensing measurement result;
when a sensing measurement result meets a first threshold, using a difference between the sensing measurement result and the first threshold as the target sensing measurement result; or
when a sensing measurement result meets a first threshold, using target information that is obtained based on the time-frequency domain channel matrix, as the target sensing measurement result,
wherein the target information comprises at least one of the following:
doppler information of a target object;
a velocity of a target object;
coordinates of a target object;
a range between a target object and a signal transceiver device;
an angle between a target object and a signal transceiver device; or
a transmission-to-reception delay of the first signal.

8. The sensing method according to claim 1, further comprising:
reporting, by the first device, the target sensing measurement result or a result of quantizing the target sensing measurement result to a second device.

9. The sensing method according to claim 8, wherein the target sensing measurement result further comprises:
a time at which the first device receives the first signal;
a time at which the first device obtains the sensing measurement result or a time at which the first device obtains the target sensing measurement result; and
time unit information corresponding to the first signal.

10. The sensing method according to claim 1, wherein before the obtaining, by a first device, at least one sensing measurement result based on at least one of a time domain variance, standard deviation, or coefficient of variation of at least one time-frequency domain channel matrix, the sensing method further comprises:
receiving first indication information, wherein the first indication information indicates at least one of the following:
sensing requirement information, wherein the sensing requirement information corresponds to at least one of a sensing measurement item, a first threshold, configuration information of a first signal, or information about a time-frequency domain channel matrix;
a sensing measurement item, wherein the sensing measurement item corresponds to the sensing measurement result;
a first threshold;
configuration information of a first signal; or
information about a time-frequency domain channel matrix.

11. The sensing method according to claim 10, wherein after the reporting, by the first device, the target sensing measurement result or a result of quantizing the target sensing measurement result to a second device, the sensing method further comprises:
receiving second indication information, wherein the second indication information is sent when the target sensing measurement result meets the first threshold, and the second indication information is used for adjusting a target parameter in the first indication information.

12. The sensing method according to claim 11, wherein the target parameter comprises at least one of the following:
the sensing requirement information;
the sensing measurement item;
the configuration information of the first signal; or
the information about a time-frequency domain channel matrix.

13. The sensing method according to claim 10, wherein the information about a time-frequency domain channel matrix comprises at least one of the following:
information about a time domain calculation window;
information about a frequency domain calculation window;
a sliding step of a time domain calculation window of a time-frequency domain channel matrix; or
information indicating a type of an element in a time-frequency domain channel matrix.

14. A sensing method, comprising:
obtaining, by a second device, a target sensing measurement result,
wherein the target sensing measurement result is obtained by a first device based on at least one sensing measurement result, the sensing measurement result is obtained based on at least one of a time domain variance, standard deviation, or coefficient of variation of a time-frequency domain channel matrix, the time-frequency domain channel matrix comprises information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points.

15. The sensing method according to claim 14, wherein before the obtaining, by a second device, a target sensing measurement result, the sensing method further comprises:
sending, by the second device, first indication information, wherein the first indication information indicates at least one of the following:
sensing requirement information, wherein the sensing requirement information corresponds to at least one of a sensing measurement item, a first threshold, configuration information of a first signal, or information about a time-frequency domain channel matrix;
a sensing measurement item, wherein the sensing measurement item corresponds to a sensing measurement result;
a first threshold;
configuration information of a first signal; or
information about a time-frequency domain channel matrix.

16. The sensing method according to claim 15, wherein after the obtaining, by a second device, a target sensing measurement result, the sensing method further comprises:
when the target sensing measurement result meets the first threshold, sending second indication information, wherein the second indication information is used for adjusting a target parameter in the first indication information.

17. The sensing method according to claim 16, wherein the target parameter comprises at least one of the following:
the sensing requirement information;
the sensing measurement item;
the configuration information of the first signal; or
the information about a time-frequency domain channel matrix.

18. The sensing method according to claim 15, wherein the information about a time-frequency domain channel matrix comprises at least one of the following:
information about a time domain calculation window;
information about a frequency domain calculation window;
a sliding step of a time domain calculation window of a time-frequency domain channel matrix; or
information indicating a type of an element in a time-frequency domain channel matrix.

19. The sensing method according to claim 14, wherein the target sensing measurement result comprises at least one of the following:
a sensing measurement result meeting the first threshold;
information about a relationship between a sensing measurement result and the first threshold;
a difference between the first threshold and a sensing measurement result that meets the first threshold; or
target information obtained based on the time-frequency domain channel matrix, wherein the target information is reported when a sensing measurement result meets the first threshold, and
the target information comprises at least one of the following:
doppler information of a target object;
a velocity of a target object;
coordinates of a target object;
a range between a target object and a signal transceiver device;
an angle between a target object and a signal transceiver device; or
a transmission-to-reception delay of the first signal.

20. A communication device, comprising: a memory storing a computer program; and a processor coupled to the memory and configured to execute the computer program to perform operations comprising:
obtaining, by the communication device, at least one sensing measurement result based on at least one of a time domain variance, standard deviation, or coefficient of variation of at least one time-frequency domain channel matrix, wherein the time-frequency domain channel matrix comprises information about frequency domain channel responses that correspond to a plurality of time-frequency domain sampling points, each time-frequency domain channel matrix corresponds to one antenna transceiver combination, the information about the frequency domain channel responses is obtained by performing channel estimation on a received first signal by the first device, the time-frequency domain channel matrix is an M×N or N×M matrix, M represents a quantity of frequency domain sampling points, and N represents a quantity of time domain sampling points; and
obtaining, by the communication device, a target sensing measurement result based on the at least one sensing measurement result.
